(19) United States
(12) Patent Application Publication
(10) Pub. No.: US 2026/0296052 A1
(43) Pub. Date: Oct. 1, 2026

(54) Methods for Darkness Calibration and Darkness Calibrating Media Processing Devices

(71) Applicant: Zebra Technologies Corporation, Lincolnshire, IL (US)

(72) Inventors: Kar Boon Oung, Singapore (SG); Gabriel Wei Quan Foo, Singapore (SG)

(21) Appl. No.: 19/091,360

(22) Filed: Mar. 26, 2025

(51) Int. Cl. B41J 2/355; B41J 11/00; B41J 29/00; G06K 15/02; G06T 7/00

(52) U.S. Cl. CPC B41J 2/3555; B41J 11/0095; B41J 29/00; G06K 15/027; G06T 7/0004; G06T 2207/30144

(57) ABSTRACT

The present disclosure provides methods for darkness calibration and darkness calibrating media processing devices. An example darkness calibrating media processing device includes a media processing device including a printhead having a plurality of darkness setpoints, an imaging sensor configured to capture image data over a field of view, and a logic circuit configured to identify data corresponding to each print region in the image data, extract a profile based on the data, determine a print ratio of black pixels to white pixels for each profile, correlate each print ratio to a darkness setpoint, select a darkness setpoint and change the darkness setpoint of the printhead.

### BACKGROUND

Thermal printheads produce heat during operation, and changing heat settings, media feed rate and throughput of a thermal printer alter the heat produced, which can cause different degree of burning of the print media. This affects the quality of the thermal printout. A user may change the operating settings of a thermal printhead to one of various darkness setpoints to achieve improved print quality.

### SUMMARY

In an example embodiment, the present disclosure provides a system, including a media processing device including a printhead having a plurality of darkness setpoints, an imaging sensor configured to capture image data over a field of view (FOV), and a logic circuit. The media processing device is configured to print, via the printhead, indicia on a media element, the indicia including a plurality of print regions, each print region containing a printout of a print design, each printout printed at a distinct darkness setpoint of the plurality of darkness setpoints, wherein each print design contains a design ratio of black pixels and white pixels, and advance the media element into the FOV of the imaging sensor, such that each print region is contained in the image data. The logic circuit is configured to identify data corresponding to each print region in the image data, extract a profile for each print region based on the data, determine, from the profile, a print ratio of black pixels to white pixels for each profile, correlate each print ratio to a corresponding distinct darkness setpoint, selecting, from the correlation, a calibration darkness setpoint corresponding to a specified calibrated ratio of black pixels to white pixels, and change the darkness setpoint of the printhead to the calibration darkness setpoint.

In an example variation of this embodiment, the printhead, the logic circuit, and the imaging sensor are integrated into direct thermal printer or a thermal transfer printer.

In an example variation of this embodiment, the printhead is integrated into a direct thermal printer or a thermal transfer printer and the logic circuit and the imaging sensor are integrated into a computing device.

In an example variation of this embodiment, the printhead is integrated into a direct thermal printer or a thermal transfer printer, the imaging sensor is integrated into an imaging device, the logic circuit is integrated with a computing device.

In an example variation of this embodiment, the logic circuit is configured to use curve fitting to correlate the print ratios and the corresponding darkness setpoints.

In an example variation of this embodiment, the imaging sensor is at least one of an optical scanner and a camera.

In an example variation of this embodiment, the plurality of print regions includes at least three print regions.

In an example variation of this embodiment, the media element is a media element of a web of media, the web of media including a plurality of media elements overlaying portions of a liner.

In an example variation of this embodiment, each printout is of an identical print design.

In an example variation of this embodiment, the imaging sensor is configured such that the FOV captures a media outlet of the media processing device.

In an example variation of this embodiment, the logic circuit is configured to store data corresponding to a media type of the media element in association with the calibration darkness setpoint.

In an example variation of this embodiment, the logic circuit is configured to store data corresponding to a print speed of the system in association with the calibration darkness setpoint.

In an example variation of this embodiment, selecting the calibration darkness setpoint includes interpolating the calibration darkness setpoint from a correlation between the each print ratio and the determined darkness setpoints.

In an example variation of this embodiment, selecting the calibration darkness setpoint includes selecting the darkness setpoint corresponding to a print ratio of the determined print ratios which is closest to the design ratio.

In an example embodiment, the present disclosure provides a system, including a printhead, having a plurality of darkness setpoints, wherein the printhead is configured to print, via the printhead, indicia on a media element, the indicia including a plurality of print regions, each print region containing a printout of a print design, each printout printed at a distinct darkness setpoint of the plurality of darkness setpoints, wherein each print design contains a design ratio of black pixels and white pixels, and a logic circuit. The logic circuit is configured to configured to receive image data corresponding to the indicia on the media element, identify data corresponding each print region in the image data, extract a profile for each print region based on the data, determine a print ratio of black pixels to white pixels for each profile, correlate each print ratio to a corresponding distinct darkness setpoint, interpolate, from the correlation, a calibration darkness setpoint corresponding to the design ratio, and change the darkness setpoint of the printhead to the calibration darkness setpoint.

In an example variation of this embodiment, the logic circuit is configured to receive the image data from a second device including an image sensor via a network.

In an example variation of this embodiment, the second device is a mobile phone.

In an example embodiment, the present disclosure provides a method for calibrating darkness of a media processing device, including printing, via a printhead of the media processing device, indicia on a media element, the indicia including a plurality of print regions, each print region containing printout of a print design printed at a distinct darkness setpoint, wherein the print design contains a design ratio of black pixels and white pixels, receiving, from an imaging device, a profile of each of the plurality of print regions, determining, for each of the plurality of print regions, a ratio of black pixels to white pixels, correlating each ratio to a corresponding distinct darkness setpoint forming a curve relating the distinct darkness setpoints and ratios, interpolating a calibrated darkness setpoint corresponding to the design ratio, and applying the calibrated darkness setpoint to the printhead.

In an example variation of this embodiment, execution of the method consumes, at most, one media element per execution.

In an example embodiment, the present disclosure provides a print medium, including a first print region including a first printout of a first print design printed at a first distinct darkness setpoint, and a second print region including a second printout of a second print design printed at a second distinct darkness setpoint.

In an example variation of this embodiment, the first print design and the second print design are a same print design.

In an example variation of this embodiment, the first print design includes first data indicating the first darkness setpoint at which the first printout is printed, and the second print design includes second data indicating the second darkness at which the second printout is printed.

Additional features and advantages of the disclosed method and apparatus are described in, and will be apparent from, the following Detailed Description and the Figures. The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the subject matter of this disclosure.

### BRIEF DESCRIPTION OF THE DRAWINGS

FIG. 1 illustrates an example media processing device, according to embodiments of the present disclosure.

FIG. 2 illustrates a flowchart of a method for calibrating print settings of the media processing device of FIG. 1, according to embodiments of the present disclosure.

FIG. 3 illustrates an example print design, according to embodiments of the present disclosure.

FIG. 4 illustrates a media element having several printouts of the print design of FIG. 3, according to embodiments of the present disclosure.

FIG. 5 illustrates an imaging device 140 capturing image data of the media element of FIG. 4, according to embodiments of the present disclosure.

FIG. 6 illustrates profiles extracted from the image data of the printouts of the media element of FIG. 4, according to embodiments of the present disclosure.

FIG. 7 illustrates an example of a print design including a data portion, according to embodiments of the present disclosure.

FIG. 8 illustrates an example processing platform configured to execute methods described herein, according to embodiments of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present technology.

The apparatus and method components have been represented where appropriate by conventional symbols in the drawings, showing only those specific details that are pertinent to understanding the embodiments of the present technology so as not to obscure the disclosure with details that will be readily apparent to those of ordinary skill in the art having the benefit of the description herein.

### DETAILED DESCRIPTION

Media processing devices may be configured to print, or otherwise impart indicia, on a variety of media types and may be configured to print at various print speeds. Generally, a user may manually adjust print settings in order to achieve a desired print quality of printed media. When changing between media types, a user may expend several media elements testing print settings in order to ensure that the print settings are tuned to produce the desired print quality on the new media type. The present disclosure provides methods and devices for calibrating print settings of a media processing device (e.g., thermal printer) without manually tuning print settings.

Generally, one or more print designs are printed several times over on a media element at varying print settings yielding several printouts. An image or scan is taken of each printout, and a sample profile is extracted from each printout. Each sample profile is analyzed to determine print ratios of printed and non-printed pixels (e.g., black pixels and white pixels, dark pixels and light pixels, colored (e.g., cyan, yellow, and/or magenta) pixels and white pixels) for the printouts. The print ratios of the printouts are compared to a design ratio of black pixels to white pixels of the print design utilized when printing the printouts, and a print setting corresponding to the printout having a print ratio that is similar to the design ratio is selected.

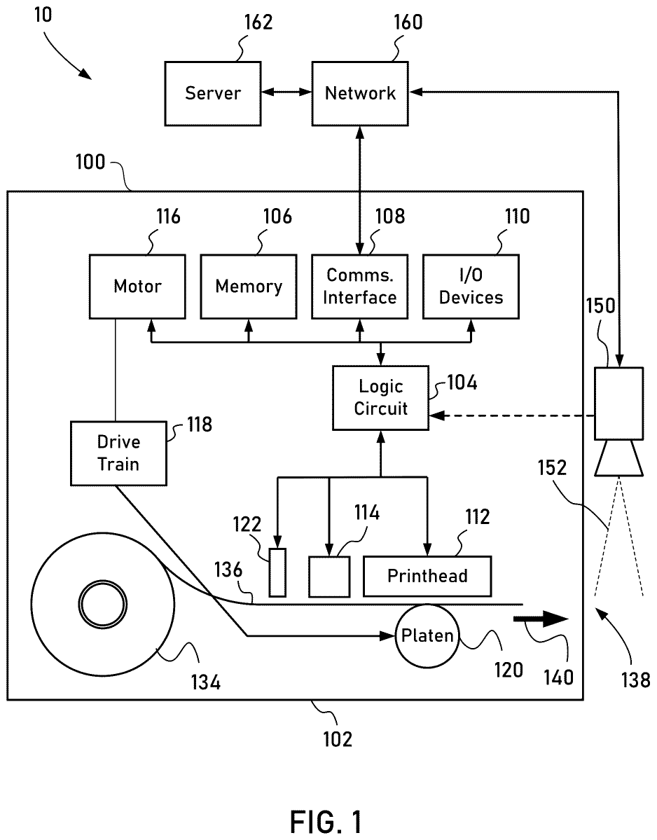

FIG. 1 illustrates a system 10, including an example media processing device 100, according to embodiments of the present disclosure. The media processing device 100 may include a housing 102. The housing 102 contains or supports one or more components of the media processing device 100 including, for example, a logic circuit 104, memory 106, a communication interface 108 (e.g., for wired and wireless communication), input/output (I/O) devices 110 (e.g., a display, switches, buttons, speakers, microphone, etc.), a printhead 112, a radiofrequency encoder/reader 114, a motor 116, a drive train 118, a platen roller 120, a sensor 122. The printhead 112 and the platen roller 120 may form a nip. In some embodiments, e.g., for thermal transfer printing, the media processing device 100 may include a ribbon supply spindle (not shown) and a ribbon take up spindle (not shown) for supporting an ink ribbon (not shown). For direct thermal embodiments, the media processing device 100 may be devoid of the ribbon supply spindle, the ribbon take-up spindle, and the ink ribbon. The housing 102 may also be configured to contain a media supply 134. As an example, the housing 102 may include a media chamber to store the media supply 134 as it is consumed by the media processing device 100. The logic circuit 104 may include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. The memory 106 is a non-transitory computer-readable medium that may include, for example, volatile (e.g., RAM, DRAM, SRAM, etc.) and/or non-volatile memory (e.g., ROM, PROM, EPROM, EEPROM, Flash memory device, optical memory device, magnetic memory device).

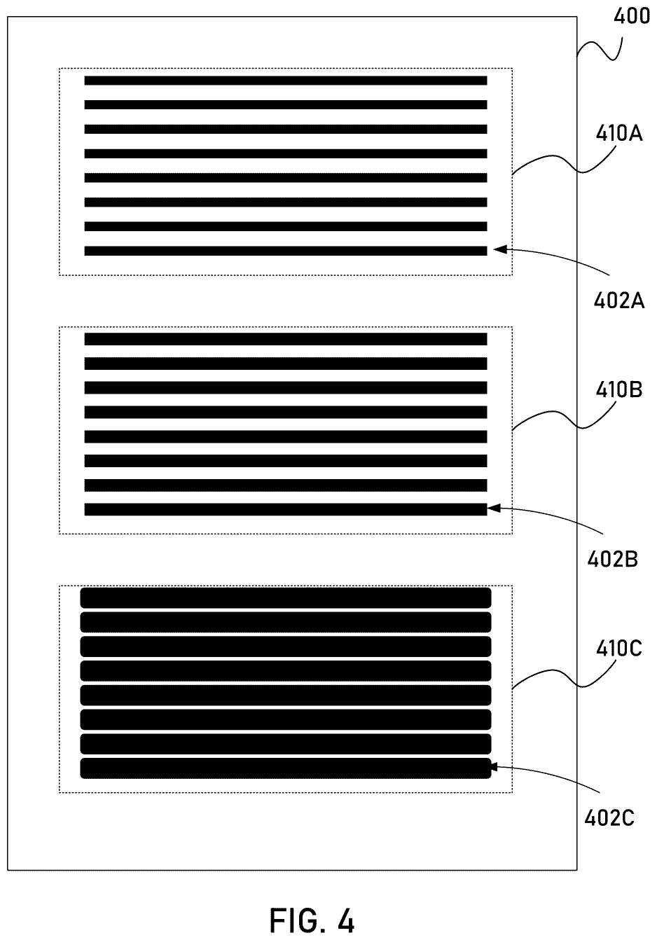

The logic circuit 104 of the media processing device 100 may be operatively coupled to the memory 106, the communications interface 108, the I/O devices 110, the printhead 112, the radiofrequency encoder/reader 114, the motor 116, the sensor 122, and/or the detector (not shown). The platen roller 120 may be driven by the motor 116 via a drive train 118 to rotate the platen roller 120 about an axis of rotation in a first direction (e.g., clockwise in the orientation shown in FIG. 1) to pull the media 136 through the feed path in a direction indicated by arrow 140 and output the media from the media processing device via a media outlet 138 formed in the housing 102 and may be driven by the motor 116 via the drive train 118 to rotate the platen roller 120 about the axis of rotation in a second direction (e.g., counterclockwise in the orientation shown in FIG. 4) to retract the media 136 (in an opposite direction than the arrow 140). In one example, the logic circuit 104 may be configured to execute code stored in the memory 106 to perform operations and functions of the media processing device 100, e.g., by communicating with and/or controlling one or more of the components of the media processing device 100. The logic circuit 104 may execute the code stored memory 106 to implement a printing operation or function that controls the motor 116 to rotate the platen roller 120 to feed the media 136 past the printhead 112, controls the printhead 112 to print on the media 136 (either directly or by transferring an ink from a ribbon to the media), and/or controls the RF encoder/reader 114 to encode and/or read radiofrequency circuits (e.g., RFID or NFC tags or inlays) included in or on the media 136. For thermal transfer printing, the printable surface of the media 136 is configured to receive a pigment (e.g., resin, wax-resin, etc.) that is transferred from the ink ribbon installed on the ribbon supply and take-up spindles and respectively, via an operation of the printhead 112. For direct thermal printing, the printhead 112 of the media processing device 100 may selectively heat the printable surface of the media 136 triggering a chemical or physical change in a thermally sensitive dye covering at least a portion of the printable surface of the media 136. After printing on the media 136, the media may be further advanced and output from media processing device 100 by the operation of the platen roller 120.

The printhead 112 may include various darkness setpoints, which may correspond to a print temperature of the printhead 112. In some examples, increasing the print temperature of the printhead 112 may increase the darkness of indicia printed on the media 136.

To ensure the printhead 112 prints at specified or desired locations on the media 136 as the media 136 passes the printhead 112, the logic circuit 104 may be configured to calibrate the media 136 relative to the printhead 112 and/or to register the media 136 relative to the printhead 112, e.g., by identifying a designated printing area on the media 136 and the logic circuit 104 may control the printhead 112 to print on the designated printing area of the media. To facilitate the identification of the designated printing areas, the media 136 may include demarcation features that may be used to locate the designated printing areas. In some instances, the demarcation features may include black marks or other indicia to indicate the designated printing areas, may include gaps between discrete media units to indicate the designated printing areas, and/or may include notches in the media. As an example, the media 136 may include a continuous web of discrete labels or wristbands, where the web or the labels/wristbands may include indicia (e.g., black marks) to demarcate adjacent labels/wristbands along a length the web. As another example, the discrete labels may be spaced apart from each other overlaying the web such that a gap exists between adjacent labels along a length of the web of (transparent or translucent) liner where the gaps may demarcate the adjacent labels along the length of the web. As an example, the media 136 may include a continuous web of labels or wristbands, where the web or the labels/wristbands may include notches to demarcate adjacent labels/wristbands along a length the web. These demarcation features may be used to identify leading edges and/or trailing edges of the labels and/or may be used to calibrate and/or register the media relative to the printhead to ensure that the logic circuit 104 controls the printhead 112 to print on the media at a specified and/or desired location (e.g., in the printing area based on a print command and/or print data).

The sensor 122 may be configured to respond to the demarcation feature between media units and to output a sensor output to the detector representative of the response to the demarcation feature which may be used by the logic circuit 104 to calibrate and/or register the media relative to the printhead 112. The sensor 122 may include an emitter and a receiver configured in a transmissive sensor configuration. However, in other example embodiments, the emitter and the receiver may be configured in a reflective sensor configuration. The sensor 122 may be an optical sensor, where the emitter may be, for example, a photodiode that emits electromagnetic energy in the light spectrum (e.g., a light signal) and receiver may be a photodetector that detects the presence or absence of the emitted electromagnetic energy (e.g., the light signal) impinging on the receiver and/or may detect variation in the intensity or power of the electromagnetic energy (e.g., the light signal) impinging on the receiver. The sensor 122 may continuously output the sensor output.

The system 10 may include an image sensor 150. In some examples, the image sensor may be integrated with the media processing device 100. In some examples the image sensor 150 may be integrated with an external imaging device, such as a mobile computing device (e.g., a mobile phone, tablet) or digital camera. In some examples, the imaging device is a camera, or an optical scanner. The imaging device may be configured to capture image data over a field of view (FOV) 152 via the image sensor 150 and transmit the image data to the logic circuit 104.

In some examples, the imaging sensor 150 is integrated with the media processing device 100 (e.g., attached to or contained within the housing 102) and the FOV 152 is oriented towards the media outlet 138 so that media 136 passes through the FOV 152 after printing.

In some examples, the system 10 can include a server 162 (or other computing device) and the media processing device 100 and/or the image sensor 150 can be in communication with the server 162 e.g., via a network 160 The server 162 can transmit data and/or instructions to, and/or receive data and/or instructions from the media processing device 100 and/or the image sensor 150.

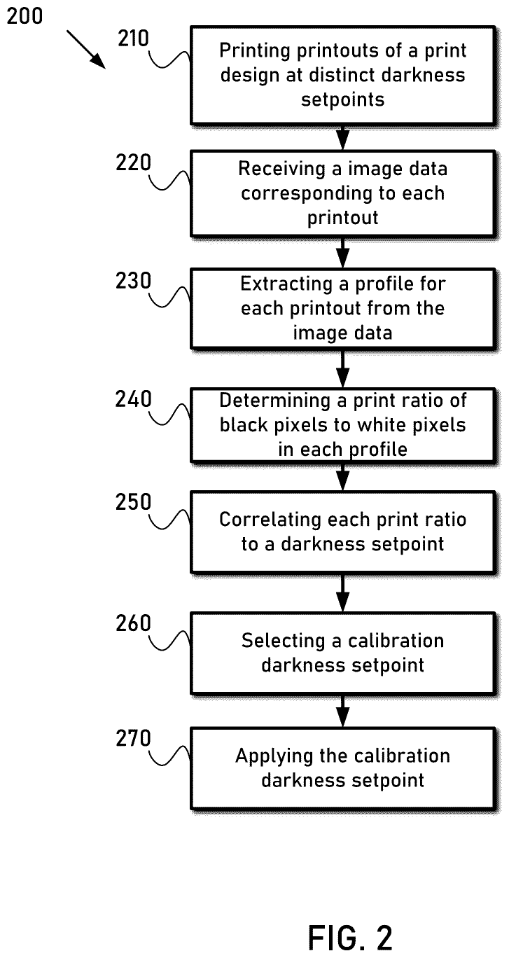

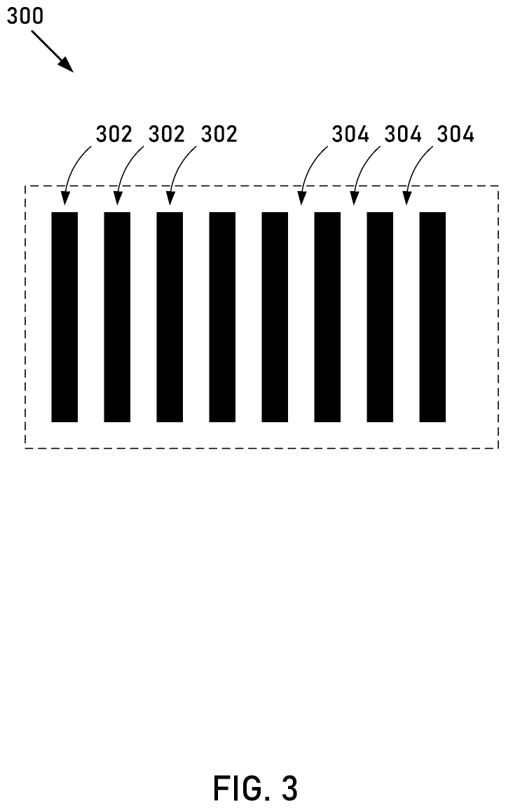

FIG. 2 illustrates a flowchart of a method 200 for calibrating print settings of a media processing device (e.g., media processing device 100). FIGS. 3-6 illustrate example print designs, example media elements, and portions of the system 10 which are relevant to, an illustrate features of, the method 200. The following discussion may refer to any of the FIGS. 2-6 concurrently. In various examples, the method 200 may be performed by the logic circuit 104 of the media processing device 100, e.g., by controlling the platen roller 120 to advance media, controlling the printhead 112 to print on the media, and/or receiving image data from the image sensor 150 for analysis of the indicia printed on the media.

Block 210 of the method 200 describes printing printouts (e.g., indicia) of a print design at distinct darkness setpoints via the media processing device 100, according to embodiments of the present disclosure. FIG. 3 illustrates an example print design 300, e.g., stored in memory 106. The print design 300 may be a digitized representation of a design to be printed on print media, such as media 136. As illustrated, the print design 300 includes black portions 302 and white portions 304. In the present example, the black portions 302 correspond to pixels to be printed on the media 136, and the white portions 304 correspond to pixels which are to remain unprinted on the media 136. A ratio of the area or widths of the black portions 302 to an area or widths of the white portions 304 is predetermined or otherwise known and referred to as a design ratio. In this disclosure, various ratios between black and white pixels are discussed (e.g., design ratios, print ratios). In various embodiments, the various ratios may be expressed as one of several metrics. The various ratios may be expressed as the ratio of black pixels to total pixels (e.g., or black areas and the total area or an aggregate black widths to a total width), the ratio of white pixels to total pixels (e.g., or white areas and the total area or an aggregate white widths to a total width), the ratio of black pixels to white pixels (e.g., or black areas and white areas an aggregate black widths to an aggregate of white width), or other similar metrics. These metrics may be expressed in percentage form, decimal form, fractional form and other forms without departing from the scope of the disclosure.

In various examples, the print design 300 may be stored in a second device, or a server, and the print design 300 is transmitted to the media processing device 100 via a network prior to printing the print design 300.

FIG. 4 illustrates a printed media element 400, according to embodiments of the present disclosure. The media element 400 includes print regions 410A-C, each print region containing a printout 402A-C of the print design 300, where each printout 402A-C is printed at a distinct darkness setpoint of the thermal printhead 112. Although illustrated with three print regions 410, greater or fewer print regions 410 containing one or more printouts 402 of the print design 300 may be printed on the media element 400.

The first print region 410A includes a first printout 402A of the print design 300, which is printed at a first darkness setpoint of the printhead 112. The second print region 410B includes a second printout 402B of the print design 300 which is printed at a second darkness setpoint of the printhead 112, the second darkness setpoint corresponding to a higher print temperature than the first darkness setpoint. The third print region 410C includes a third printout 402C of the print design 300 which is printed at a third darkness setpoint of the printhead 112, the third darkness setpoint corresponding to a higher print temperature than the second darkness setpoint.

After the printouts 402A-C are printed on the media element 400 (e.g., as described by block 210 of the method 200) a spectrum of results is produced. As illustrated, in the first printout 402A is not as dark as the print design 300, which may be a product of underprinting, where the print temperature was insufficient to develop all of the black portions of the print design 300. The second printout 402B closely resembles the print design 300. The third printout 402C is darker than the print design 300, which may be a product of overprinting, where the print temperature is so high that when pixels in the black portions 302 of the print design 300 are printed, pixels in the white portions 304 of the print design 300 are developed and appear as printed pixels in the print design 300.

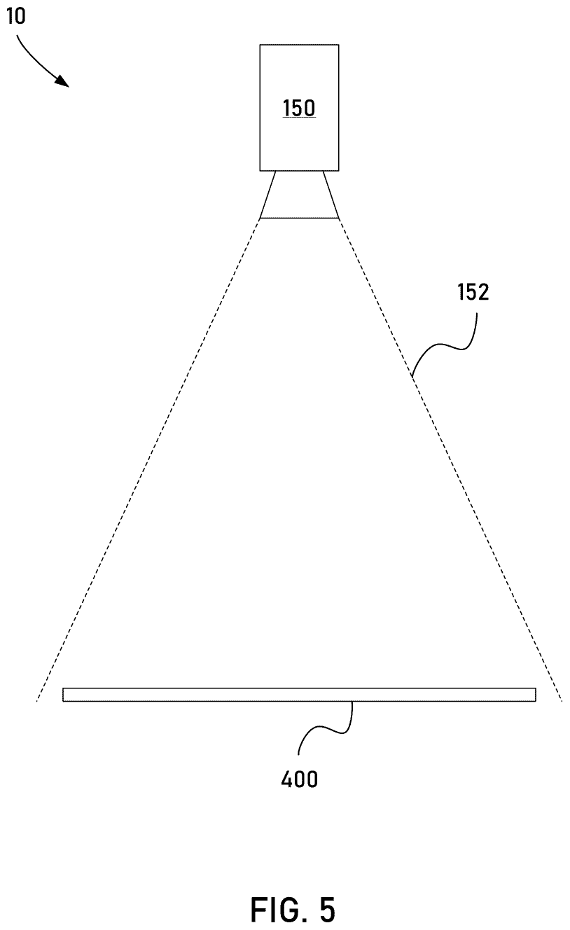

Block 220 of the method 200 describes receiving image data corresponding to each printout 402 from the image sensor 150, according to embodiments of the present disclosure. FIG. 5 illustrates a portion of the system 1000, in which the media element 400 placed within the FOV 152 of the image sensor 150, according to embodiments of the present disclosure. After the media element 400 is printed, the media element 400 is placed into the FOV 152 of the image sensor 150. In some examples, the logic circuit 104 may control the drive train 118 to advance the media element 400 out of the housing 102 of the media processing device 100 and into the FOV 152 of the image sensor 150.

In some examples, a user may remove the media element 400 from the media processing device 100 and place the media element 400 within the FOV 152 of the image sensor 150. In some such examples, a user may operate an imaging device including the image sensor 150 and manipulate the FOV 152 to capture image data of the media element 400.

Generally, image data corresponding to the media element 400 is captured by the image sensor 150 and transmitted to the logic circuit 104, which receives the image data.

In various examples, the image data many be transmitted via a network to a second device including a processor, or a server 162.

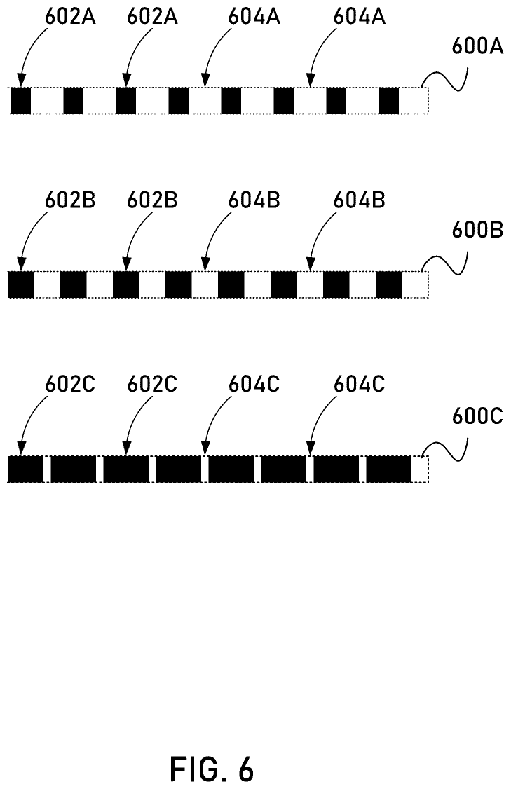

Block 230 of the method 200 describes extracting a profile from the image data, according to embodiments of the present disclosure. For example, the logic circuit 104 extracts a profile 600 from each printout 402 (each printout 402A-C having a respective profile 600A-C). In some examples, the logic circuit 104 is configured to identify bounds, or region limits, of each of the print regions 410. Once each print region 410 is identified, the logic circuit identifies a portion of the print region 410 having predetermined proportions and/or a predetermined location relative to the region limits and extracts the portion as a profile 600 of the print region 410. In some examples, each profile 600 is a “slice” as illustrated in FIG. 6, although profiles 600 having other shapes or forms are contemplated. In some examples, each profile 600 is of a predetermined quantity of pixels.

In various examples where the image data is transmitted to a second device or server 162, the second device or server 162 may process the image data to extract the profiles 600.

Block 240 of the method 200 describes determining a print ratio of black pixels to white pixels in each profile 600, according to embodiments of the present disclosure. The print ratio may be determined by determining a reflectance of each profile 600.

In various examples, each profile 600 may be subdivided into pixels, and a binary determination made by the logic circuit 104 as to whether each pixel is black or white, and the results summed to yield a print ratio between printed and non-printed pixels.

In various examples, the logic circuit 104 may identify a width of each black portion 302 in the profile and a width of each white portion 304 in the profile and determine the print ratio as the ratio between the total width of the black portions 602 and the total width of the white portions 604.

In various examples where the image data is transmitted to a second device or server 162, the second device or server 162 may process the profiles 600 to determine the print ratios.

Block 250 of the method 200 describes correlating each print ratio of each profile to a corresponding darkness setpoint used to print the printouts from which the profiles 600 are generated, according to embodiments of the present disclosure. Once the print ratio has been determined for each profile 600, the logic circuit 104 correlates the print ratio of each profile 600 with the darkness setpoint at which the printout 402 having the profile 600 was printed.

In various examples, the logic circuit 104 may logically correlate print ratios to darkness settings. For example, the lowest darkness setpoint is generally expected to have the lowest print ratio, therefore the logic circuit 104 correlates the lowest print ratio with the lowest darkness setpoint, and the highest print ratio with the highest darkness setpoint, and so on and so forth.

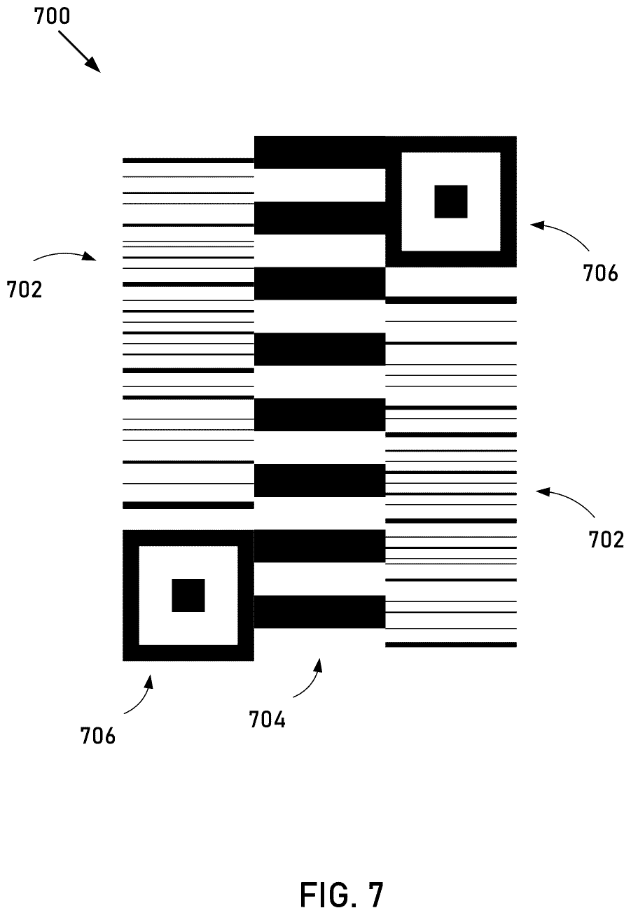

In some examples, the logic circuit 104 may receive or interpret data to determine which print ratio corresponds to which print setting. In some such examples, each printout 402 may include a unique print design 700 which includes an identifier which is decodable by the logic circuit 104 upon receiving image data of the media element 400. FIG. 7 illustrates an example of a unique print design 700, according to embodiments of the present disclosure.

The unique print design 700 includes a data region 702, which includes indicia configured to indicate the darkness setting at which the unique print design 700 is to be printed. In various examples, the indicia in the data region 702 may include a machine readable dataform, such as a barcode or QR code, or human readable indicia, such as natural language text.

In various examples, the unique print design includes a profile region 704, such that a profile 600 may be extracted from the image data of a printout thereof corresponding to the profile region 704 by the logic circuit 104. In various examples, the profile region 704 contains the print design 300. Generally, the profile region has the design ratio of black and white pixels.

In various examples, the profile region 704 may be the data region 702. In such examples, the indicia in the data region 702 have the design ratio, such that a profile 600 may be extracted from the image data corresponding to the data region 702 by the logic circuit 104.

In various examples, a unique print design 700 includes orienting indicia 706, which are configured to indicate to the logic circuit 104 receiving image data of a printout thereof, where the data region 702 and the profile region 704 are located within the printout of the unique print design 700.

In various examples, the logic circuit 104 may correlate print ratios to darkness settings based on an orientation of the printouts 402 on the media element 400. In some such examples, the printouts 402 may be printed in an orientation relative to one another which encodes data as to which printout 402 is which (e.g., and at which darkness setting the printout 402 was printed). The logic circuit 104 may decode this data upon receiving image data of the media element 400 and correlate the print ratios accordingly.

In various examples, printing the printouts (e.g., as described at block 410) and receiving the image data (e.g., as described at block 420) may be sequenced such that a first subset of image data received by the logic circuit 104 at a first time corresponds to a first printout at a known darkness setpoint, and a second subset of image data received at a second, later time, corresponds to a second printout at a second known darkness setpoint, printed after the first printout, and so on and so forth. In this manner, the logic circuit 104 may correlate darkness setpoints with the print ratios based on the chronologic order in which the subsets of image data are received and the order in which the printouts 400 are printed.

In various examples where the image data is transmitted to a second device or server 162, the second device or server 162 may correlate the print ratios to darkness settings.

Block 260 of the method 200 describes selecting a calibration darkness setpoint, according to embodiments of the present disclosure. After determining the darkness setpoints which correspond to the print ratios, the logic circuit 104 selects a darkness setpoint which will produce printouts having a print ratio closest to the design ratio and selects that darkness setpoint. The selected darkness setpoint is referred to as the calibration darkness setpoint.

In some examples, it may be practical to print a printout 402 for each darkness setpoint. In such examples, a print ratio is determined for each darkness setpoint, and the logic circuit 104 selects the darkness setpoint which produces the print ratio closest to the design ratio.

In some examples, it may be impractical to print a printout 402 for each darkness setpoint, and thus print ratios are not available for each darkness setpoint. In some such examples, once the known print ratios are correlated to the known darkness setpoints, the logic circuit 104 may calculate expected print ratios to the remaining darkness setpoints based on the known print ratios. In some such examples, the logic circuit 104 may interpolate the calibration darkness setting, e.g., by employing curve fitting methods or algorithms to generate expected or estimated values for print ratios between the known print ratios.

In some examples, if the lowest known print ratio is below the design ratio, and the highest print ratio is above the design ratio, the logic circuit 104 may identify a corresponding window of darkness settings and exclusively perform calculations for expected or estimated print ratios of darkness settings within the corresponding window.

In some examples, if a known print ratio is within a predetermined margin of the design ratio, the logic circuit 104 may forego calculation of the expected or estimated print ratios of the remaining darkness settings and select the darkness ratio corresponding to the known print ratio as the calibration darkness setting. In some examples, the predetermined margin may be less than 10%, less than 5% or less than 1%, although other margins are contemplated.

In various examples where the image data is transmitted to a second device or server, the second device or server 162 may select the darkness setpoint.

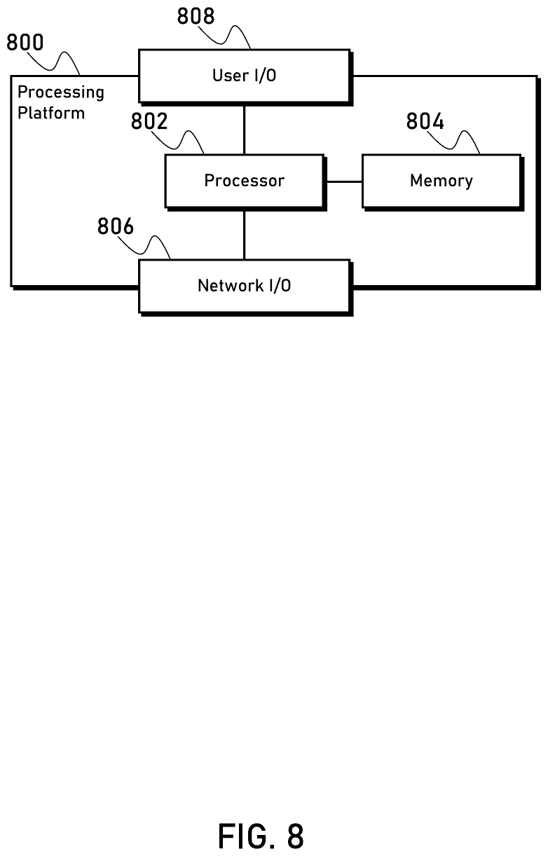

Block 270 of the method 200 describes applying the calibration darkness setpoint, according to embodiments of the present disclosure. In some examples, once the calibration darkness setpoint is selected by the logic circuit 104, the logic circuit 104 implements the calibration darkness setpoint in the media processing device 100. In some examples, the logic circuit 104 may transmit data to a user interface (e.g., user I/O 808, see FIG. 8) indicating the calibration darkness setpoint, such that a user may manually adjust the darkness setpoint of the media processing device 100.

In various examples, at block 270 data regarding a media type of the media 136 may be obtained by the logic circuit, and the logic circuit 104 stores the calibration darkness setting along with the data regarding the media type in the memory 106. As a non-limiting example, if the method 200 is performed using Type #3 Receipt Stock as the media 136, and the calibration darkness setpoint is determined to be darkness setpoint #6, the logic circuit 104 may store the foregoing information such that the next time Type #3 Receipt Stock is to be printed in the media processing device 100, upon receiving information indicating that the media 136 to be printed is Type #3 Receipt Stock, the logic circuit 104 automatically selects darkness setpoint #6, such that executing the method 200 may be foregone.

In various examples, at block 270 data regarding a feed rate of the media 136 through the media processing device 100 may be obtained by the logic circuit 104, and the logic circuit 104 stores the calibration darkness setting along with the data regarding the feed rate in the memory 106. As a non-limiting example, if the method 200 is performed using a feed rate of 2 inches per second (IPS), and the calibration darkness setpoint is determined to be darkness setpoint #12, the logic circuit 104 may store the foregoing information such that the next time the media processing device 100 engages in a media process which employs a feed rate of 2 IPS, the logic circuit 104 automatically selects darkness setpoint #12, such that executing the method 200 may be foregone.

In various examples, both the feed rate and media type may be stored in conjunction with the calibration darkness setpoint.

After the block 270, the method 200 may be concluded. In some examples, a printing process may be commenced by the media processing device 100 after the conclusion of the method 200.

Generally, the method 200 is configured such that the method 200 is executable such that the media processing device 100 expends, at most one media element 400 per execution. Examples in which multiple media elements 400 are expended are also contemplated.

FIG. 8 is a block diagram representative of an example processing platform 800 capable of implementing, for example, one or more components of the example media processing device 100 of FIG. 1 or, more generally, the example logic circuit 104. The example processing platform 800 of FIG. 8 is capable of executing instructions to, for example, implement operations of the method 200, as may be represented by the flowcharts of the FIG. 2 and the description thereof. Other example logic circuits capable of, for example, implementing operations of the example methods described herein include field programmable gate arrays (FPGAs) and application specific integrated circuits (ASICs).

The example processing platform 800 of FIG. 8 includes a processor 802 such as, for example, one or more microprocessors, controllers, and/or any suitable type of processor. The example processing platform 800 of FIG. 8 includes memory (e.g., volatile memory, non-volatile memory) 804 (e.g., which may be the memory 106 of the media processing device 100, or a separate memory distinct from the media processing device 100) accessible by the processor 802 (e.g., via a memory controller). The example processor 802 interacts with the memory 804 (e.g., or the memory 106 of the media processing device 100) to obtain, for example, machine-readable instructions stored in the memory 804 corresponding to, for example, the operations represented by the flowcharts of this disclosure. Additionally, or alternatively, machine-readable instructions corresponding to the example operations described herein may be stored on one or more removable media (e.g., a compact disc, a digital versatile disc, removable flash memory, etc.) that may be coupled to the processing platform 800 to provide access to the machine-readable instructions stored thereon.

The example processing platform 800 of FIG. 8 also includes a network interface 806 to enable communication with other machines via, for example, one or more networks. The example network interface 806 includes any suitable type of communication interface(s) (e.g., wired and/or wireless interfaces) configured to operate in accordance with any suitable protocol(s).

The example, processing platform 800 of FIG. 8 also includes input/output (I/O) interfaces 808 to enable receipt of user input and communication of output data to the user.

The above description refers to a block diagram of the accompanying drawings. Alternative implementations of the example represented by the block diagram includes one or more additional or alternative elements, processes and/or devices. Additionally, or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the technology the present disclosure as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive and should instead be understood as potentially combinable if such combinations are permissive in any manner. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed technology is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain manner is configured in at least that manner but may also be configured in manner that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, relevant subject matter may lie in less than all features of a single disclosed embodiment. Thus, the following claims are hereby incorporated into the Detailed Description, with each claim standing on its own as a separately claimed subject matter.

1. A system, comprising:
a media processing device comprising a printhead having a plurality of darkness setpoints;
an imaging sensor configured to capture image data over a field of view (FOV); and
a logic circuit;
wherein the media processing device is configured to:
print, via the printhead, indicia on a media element, the indicia comprising a plurality of print regions, each print region containing a printout of a print design, each printout printed at a distinct darkness setpoint of the plurality of darkness setpoints, wherein each print design contains a design ratio of black pixels and white pixels, and
advance the media element into the FOV of the imaging sensor, such that each print region is contained in the image data;
wherein the logic circuit is configured to:
identify data corresponding to each print region in the image data,
extract a profile for each print region based on the data,
determine, from the profile, a print ratio of black pixels to white pixels for each profile,
correlate each print ratio to a corresponding distinct darkness setpoint;
selecting, from the correlation, a calibration darkness setpoint corresponding to a specified calibrated ratio of black pixels to white pixels, and
change the darkness setpoint of the printhead to the calibration darkness setpoint.

2. The system of claim 1, wherein the printhead, the logic circuit, and the imaging sensor are integrated into direct thermal printer or a thermal transfer printer.

3. The system of claim 1, wherein the printhead is integrated into a direct thermal printer or a thermal transfer printer and the logic circuit and the imaging sensor are integrated into a computing device.

4. The system of claim 1, wherein the printhead is integrated into a direct thermal printer or a thermal transfer printer, the imaging sensor is integrated into an imaging device, the logic circuit is integrated with a computing device.

5. The system of claim 1, wherein the logic circuit is configured to use curve fitting to correlate the print ratios and the corresponding darkness setpoints.

6. The system of claim 1, wherein the imaging sensor is at least one of an optical scanner and a camera.

7. The system of claim 1, wherein the plurality of print regions comprises at least three print regions.

8. The system of claim 1, wherein the media element is a media element of a web of media, the web of media comprising a plurality of media elements overlaying portions of a liner.

9. The system of claim 1, wherein each printout is of an identical print design.

10. The system of claim 1, wherein the imaging sensor is configured such that the FOV captures a media outlet of the media processing device.

11. The system of claim 1, wherein the logic circuit is configured to store data corresponding to a media type of the media element in association with the calibration darkness setpoint.

12. The system of claim 1, wherein the logic circuit is configured to store data corresponding to a print speed of the system in association with the calibration darkness setpoint.

13. The system of claim 1, wherein selecting the calibration darkness setpoint includes interpolating the calibration darkness setpoint from a correlation between each print ratio and the determined darkness setpoints.

14. The system of claim 1, wherein selecting the calibration darkness setpoint includes selecting the darkness setpoint corresponding to a print ratio of the determined print ratios which is closest to the design ratio.

15. A system, comprising:
a printhead, having a plurality of darkness setpoints, wherein the printhead is configured to print, via the printhead, indicia on a media element, the indicia comprising a plurality of print regions, each print region containing a printout of a print design, each printout printed at a distinct darkness setpoint of the plurality of darkness setpoints, wherein each print design contains a design ratio of black pixels and white pixels; and
a logic circuit configured to:
receive image data corresponding to the indicia on the media element,
identify data corresponding each print region in the image data,
extract a profile for each print region based on the data,
determine a print ratio of black pixels to white pixels for each profile,
correlate each print ratio to a corresponding distinct darkness setpoint,
interpolate, from the correlation, a calibration darkness setpoint corresponding to the design ratio, and
change the darkness setpoint of the printhead to the calibration darkness setpoint.

16. The system of claim 15, wherein the logic circuit is configured to receive the image data from a second device comprising an image sensor via a network.

17. The system of claim 16, wherein the second device is a mobile phone.

18. A method for calibrating darkness of a media processing device, comprising:
printing, via a printhead of the media processing device, indicia on a media element, the indicia comprising a plurality of print regions, each print region containing printout of a print design printed at a distinct darkness setpoint, wherein the print design contains a design ratio of black pixels and white pixels;
receiving, from an imaging device, a profile of each of the plurality of print regions;
determining, for each of the plurality of print regions, a ratio of black pixels to white pixels;
correlating each ratio to a corresponding distinct darkness setpoint forming a curve relating the distinct darkness setpoints and ratios;
interpolating a calibrated darkness setpoint corresponding to the design ratio; and
applying the calibrated darkness setpoint to the printhead.

19. The method of claim 18, wherein execution of the method consumes, at most, one media element per execution.

20-22. (canceled)
